(19) United States
(12) Patent Application Publication
(10) Pub. No.: US 2010/0209817 A1
(43) Pub. Date: Aug. 19, 2010

(54) FUEL CELL SYSTEM AND ELECTRONIC DEVICE

(75) Inventors: Yuto Takagi, Kanagawa (JP); Kazuaki Fukushima, Kanagawa (JP); Jusuke Shimura, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/679,415

(22) PCT Filed: Sep. 25, 2008
(86) PCT No.: PCT/JP2008/067339

§ 371 Date: Mar. 22, 2010

(30) Foreign Application Priority Data
Sep. 28, 2007 (JP) P2007-255697

(51) Int. Cl. H01M 8/04

(52) U.S. Cl. 429/513

(57) ABSTRACT

A fuel cell system with which excessive supply or supply shortage of a vaporized fuel is able to be avoided and stable power generation with high output is able to be made, and an electronic device using the same. In a vaporization chamber, a projection is provided as a heat conduction section to conduct heat generated in a power generation section to a liquid fuel supplied to the vaporization chamber. Between the end of the projection and an inner wall face of an inner member, a gap is provided. In the gap, the heat is effectively conducted to the liquid fuel supplied from the end of a fuel supply route, and the liquid fuel is vaporized. It is possible that the projection is contacted with a section in the vicinity of the end section of the fuel supply route in the inner wall face of the inner member, and thereby heat of the power generation section is conducted to the inner member through the projection, heat is conducted to the liquid fuel through the inner member, and the liquid fuel is vaporized. Thereby, it is possible to limit a target region to be heated according to the position of the projection, or to control the amount of heat conducted to the liquid fuel according to the size of the projection.

### CROSS REFERENCE TO RELATED APPLICATIONS

The present applications is a National Stage of International Application No. PCT/JP2008/067339 filed on Sep. 25, 2008 and which claims priority to Japanese Patent Application No. 2007-255697 filed on Sep. 28, 2007, the entire contents of which are being incorporated herein by reference.

### BACKGROUND

The present invention relates to a fuel cell system and an electronic device using the same.

A fuel cell has a structure in which an electrolyte is arranged between an anode electrode (fuel electrode) and a cathode electrode (oxygen electrode). A fuel is supplied to the anode electrode, and an oxidant is supplied to the cathode electrode. At this time, redox reaction in which the fuel is oxidized by the oxidant is initiated, and chemical energy contained in the fuel is converted to electric energy.

Such a fuel cell is able to continuously generate power by continuously supplying the fuel and the oxidant. Thus, the fuel cell is expected as a new power source for a mobile electronic device different from the existing primary battery or the existing secondary battery. That is, since the fuel cell generates power by using chemical reaction between the fuel and the oxidant, if oxygen in the air is used as the oxidant and the fuel is continuously resupplied from outside, the fuel cell is able to be continuously used as a power source unless the fuel cell goes out of order. Thus, a downsized fuel cell is able to become a high energy density power source that is suitable for a mobile electronic device without necessity of charging.

Various types of fuel batteries have been already proposed or experimentally produced, and part thereof is practically used. Since characteristics of these fuel batteries are largely changed according to the electrolyte used, these fuel batteries are categorized into various types according to the electrolyte type. Of the foregoing fuel batteries, a Polymer Electrolyte Fuel Cell (PEFC) in which a proton conductive polymer film is used does not need an electrolytic solution and is operated at comparatively low temperature such as about from 30 deg C. to 130 deg C. both inclusive. Thus, the PEFC is regarded as a fuel cell that is able to be downsized and is suitable as a power source for a mobile electronic device.

As a fuel of the fuel cell, various materials such as hydrogen and methanol are able to be used. Specially, a liquid fuel such as methanol is prospective as a fuel of the fuel cell for a mobile electronic device since the liquid fuel has a higher density than the density of gas and is easily stored. Specially, a Direct Methanol Fuel Cell (DMFC) in which methanol is directly supplied to an anode electrode of the PEFC and reaction is initiated does not need a reformer to extract hydrogen from the fuel, the structure thereof is simplified, and its size is easily reduced.

In the DMFC, the fuel methanol is oxidized into carbon dioxide in a catalyst layer of the anode electrode as shown in Chemical formula 1.

(Chemical formula 1)

Anode electrode: CH₃OH+H₂O→CO₂+6H⁺+6e⁻

Hydrogen ions generated at this time are moved to a cathode electrode through an electrolyte film provided between the anode electrode and the cathode electrode, are reacted with oxygen in a catalyst layer of the cathode electrode to generate water as shown in Chemical formula 2.

(Chemical formula 2)

Cathode electrode: 6H⁺+(3/2)O₂+6e⁻+→3H₂O

Reaction initiated in the entire DMFC is expressed by Chemical formula 3 obtained by integrating Chemical formula 1 and Chemical formula 2.

(Chemical formula 3)

Entire DMFC: CH₃OH+(3/2)O₂→CO₂+2H₂O

As a method of supplying methanol to the anode electrode of the DMFC, liquid supply type method and gas supply type method have been proposed. The liquid supply type method is a method in which a liquid fuel is directly supplied to the anode electrode by using a pump or the like. At this time, in the DMFC, water is consumed by electrode reaction in the anode electrode (Chemical formula 1). Thus, it is often the case that a methanol aqueous solution is supplied to the anode electrode to resupply water for the consumed portion.

However, in this method, methanol crossover in which methanol is moved from the anode electrode side to the cathode electrode side through the electrolyte film is easily generated, methanol usage efficiency is lowered, and reaction is not effectively promoted unless the fuel concentration is decreased. However, if the fuel concentration is decreased, in addition to lowering of energy density, excessive water reaches the cathode electrode, resulting in flooding phenomenon.

Further, in this method, carbon dioxide generated by electrode reaction in the anode electrode (Chemical formula 1) is adhered to the anode electrode to prevent supplying methanol to the anode electrode. Thus, it causes lowering of the output or instability.

Meanwhile, the gas supply type method is a method in which a gas-liquid separator is arranged between a liquid phase section and a gas phase section, and methanol in a state of gas is supplied to the anode electrode. In this method, it is possible that water generated in the cathode electrode (Chemical formula 2) is inversely diffused to the anode electrode side, water retention on the cathode electrode is prevented, and alternative portion of water consumed by the electrode reaction in the anode electrode (Chemical formula 1) is able to be resupplied. Thus, a highly-concentrated methanol is able to be used, and moisture in the electrolyte film is able to be retained by self-humidification, and high proton conductivity is able to be demonstrated in the electrolyte film. Further, carbon dioxide generated in the anode electrode does not become air bubbles, and is easily exhausted.

In the gas supply type DMFC, in order to demonstrate the performance at a maximum, it is desirable that a sufficient amount of vaporized fuel for realizing power generation is continuously and uniformly supplied to the power generation section composed of a fuel cell. To vaporize a liquid fuel, reaction heat generated in the power generation section is able to be used. Further, by using a porous body as the gas-liquid separator, heat conduction to the liquid fuel is able to be promoted (for example, refer to Patent Document 1)

[Patent Document 1] Japanese Unexamined Patent Application Publication No. 2001-15130

[Patent Document 2] Japanese Unexamined Patent Application Publication No. 2006-221948

However, in the existing technology described in Patent Document 1, there has been a possibility that being influenced by environment temperature or power generation state of the power generation section, heat conduction becomes excessive. In this case, due to the excessive heat conduction, the gas fuel is excessively supplied to the power generation section. In result, crossover is increased or temperature of the power generation section is excessively increased, and thereby power generation efficiency is lowered.

It has been proposed to increase power generation efficiency of the fuel cell by supplying a fuel whose amount is necessary for reaction in the fuel cell (for example, refer to Patent document 2). However, in this existing technology, heat input into the fuel vaporization section depends on radiation from the device and natural convection in the vaporization chamber. Thus, there is a possibility that heat conduction to the fuel vaporization section or the liquid fuel is lacked, and there is room for improvement.

In view of the foregoing problems, it is desirable to provide a fuel cell system with which excessive supply or supply shortage of a vaporized fuel is able to be avoided and stable power generation with high output is able to be made, and an electronic device using the same.

### SUMMARY

A fuel cell system according to an embodiment includes the following elements (A) to (D). Thereby, a more appropriate amount of vaporized fuel is able to be supplied to a power generation section, and high output and power generation stability are realized.

(A) a power generation section including an electrolyte between an anode electrode and a cathode electrode;

(B) a fuel supply control section that supplies a liquid fuel whose amount is based on a stoichiometric fuel consumption according to a power generation amount of the power generation section;

(C) a fuel vaporization section that is arranged adjacent to the anode electrode, and has a vaporization chamber to which the liquid fuel from the fuel supply control section is supplied; and

(D) a heat conduction section that is formed in the vaporization chamber, and conducts heat generated in the power generation section to the liquid fuel supplied to the vaporization chamber.

“Amount based on the stoichiometric fuel consumption” means an amount calculated based on the stoichiometric fuel consumption, and is not necessarily equal to the stoichiometric fuel consumption. For example, the “amount based on the stoichiometric fuel consumption” may be about (stoichiometric fuel consumption)*1.5.

In the fuel cell system of the present invention, the fuel supply control section supplies the liquid fuel whose amount is based on the stoichiometric fuel consumption according to the power generation amount of the power generation section to the vaporization chamber of the fuel vaporization section arranged adjacent to the anode electrode. Since the heat conduction section is formed in the vaporization chamber, heat generated in the power generation section is conducted to the liquid fuel by the heat conduction section. Thus, there is no possibility that excessive supply of the vaporized fuel due to excessive conduction exists. Meanwhile, there is no possibility that supply shortage of the vaporized fuel due to lack of heat conduction exists. An appropriate amount of the liquid fuel is surely vaporized and the vaporized fuel is supplied to the power generation section.

An electronic device according to the embodiment includes a fuel cell system. The fuel cell system is composed of the fuel cell system of the foregoing present invention.

The electronic device of the embodiment includes the fuel cell system with high output capable of stably generating power stably according to the foregoing present invention. Thus, in the electronic device of the present invention, multifunction and high performance associated with increased electric power consumption are able to be addressed.

According to the fuel cell system of the present embodiment, the fuel supply control section supplies the liquid fuel whose amount is based on the stoichiometric fuel consumption according to the power generation amount of the power generation section to the vaporization chamber. In addition, the heat conduction section to conduct heat generated in the power generation section to the liquid fuel supplied to the vaporization chamber is provided in the vaporization chamber. Thus, excessive supply or supply shortage of the fuel and the like are able to be avoided. Therefore, a high output is able to be obtained, and stability of the power generation is able to be improved. Accordingly, the fuel cell system of the present invention is also suitable for an electronic device having high electric power consumption, multi functions, and high performance.

Additional features and advantages are described herein, and will be apparent from, the following Detailed Description and the figures.

### BRIEF DESCRIPTION OF THE FIGURES

FIG. 1 is a view illustrating a schematic structure of an electronic device including a fuel cell system according to a first embodiment.

FIG. 2 is a view illustrating a structure of the power generation section and the fuel vaporization section illustrated in FIG. 1.

FIG. 3 is a view illustrating another example of the fuel vaporization section illustrated in FIG. 2.

FIG. 4 is a view illustrating a structure of a power generation section and a fuel vaporization section according to a second embodiment.

FIG. 5 is a view illustrating a modified example of FIG. 4.

FIG. 6 is a view illustrating a structure of a power generation section and a fuel vaporization section according to a third embodiment.

FIG. 7 is a view illustrating a structure of a power generation section and a fuel vaporization section according to a fourth embodiment.

FIG. 8 is a view illustrating a modified example of FIG. 7.

FIG. 9 is a view illustrating a structure of a power generation section and a fuel vaporization section according to a fifth embodiment.

FIG. 10 is a view illustrating a structure of a power generation section and a fuel vaporization section according to a sixth embodiment.

FIG. 11 is a view illustrating a modified example of FIG. 9.

FIG. 12 is a view illustrating another modified example of FIG. 9.

FIG. 13 is a view illustrating a result of an example.

FIG. 14 is a view illustrating a result of Comparative example 1.

FIG. 15 is a view illustrating long term power generation characteristics of the example.

FIG. 16 is a view illustrating long term power generation characteristics of Comparative example 2.

### DETAILED DESCRIPTION

Embodiments will be hereinafter described in detail.

### First Embodiment

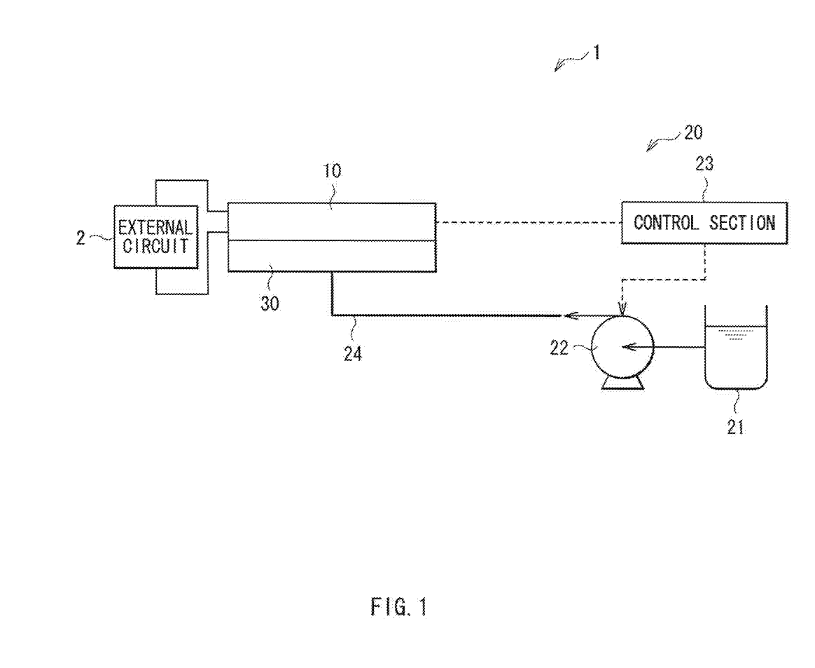

FIG. 1 illustrates a schematic structure of an electronic device having a fuel cell system according to a first embodiment. The electronic device is, for example, a mobile electronic device such as a mobile phone and a notebook PC (Personal Computer). The electronic device includes a fuel cell system 1 and an external circuit (load) 2 driven by electric energy generated in the fuel cell system 1. The fuel cell system 1 has, for example, a power generation section 10, a fuel supply control section 20, and a fuel vaporization section 30.

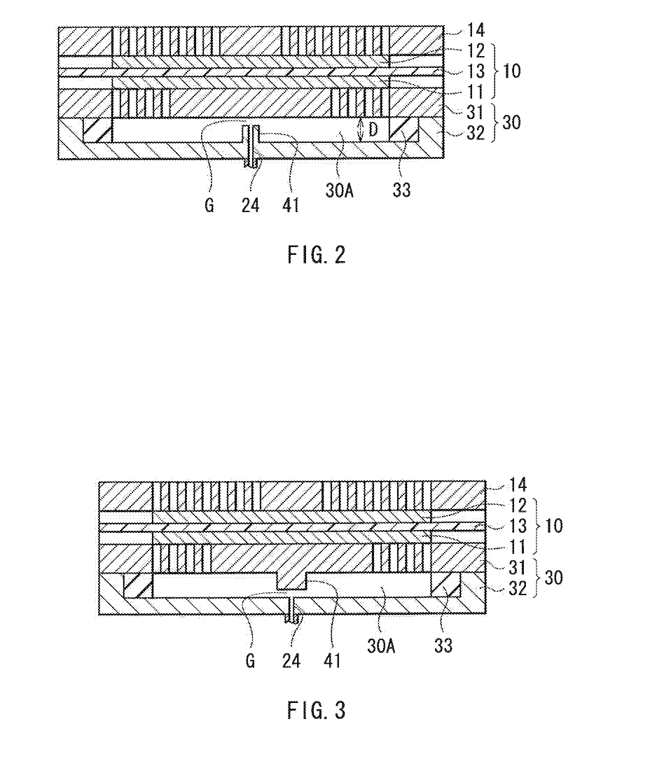

FIG. 2 illustrates an example of the power generation section 10 and the fuel vaporization section 30. The power generation section 10 is, for example, a DMFC including an electrolyte film 13 between an anode electrode 11 and a cathode electrode 12. The anode electrode 11 and the cathode electrode 12 have a structure in which a catalyst layer containing platinum (Pt), ruthenium (Ru) or the like is formed on a surface of a carbon cloth or the like, and a current collector such as titanium (Ti) mesh is provided on the rear face thereof. The electrolyte film 13 is made of, for example, a polyperfluoroalkyl sulfonic acid resin (“Nafion (registered trademark),” Du Pont make) or other resin film having proton conductivity. The anode electrode 11, the cathode electrode 12, and the electrolyte film 13 are fixed by a gasket (not illustrated).

Outside of the cathode electrode 12 of the power generation section 10, a package member 14 is provided. The package member 14 is, for example, 2.0 mm thick, and is made of a material generally purchasable such as a titanium (Ti) plate and an acid-resistant metal plate. The material thereof is not particularly limited. A through hole through which air, that is, oxygen passes is provided in the package member 14, and air, that is, oxygen is supplied to the cathode electrode 12 through the through hole.

The fuel supply control section 20 illustrated in FIG. 1 is intended to supply a liquid fuel whose amount is based on a stoichiometric fuel consumption according to the power generation amount of the power generation section 10. The fuel supply control section 20 includes, for example, a fuel tank 21, a fuel pump 22, a control section 23, and a fuel supply route 24. The control section 23 is intended to control power generation state of the power generation section 10, and simultaneously controls the fuel supply amount of the fuel pump 22.

The fuel vaporization section 30 illustrated in FIG. 2 is arranged adjacent to the anode electrode 11 of the power generation section 10, and has a vaporization chamber 30A to which a liquid fuel from the fuel supply control section 20 is supplied. More specifically, the fuel vaporization section 30 has an inner member 31 arranged being contacted with the anode electrode 11 and an outer member 32 arranged oppositely to the inner member 31. An internal space surrounded by the inner member 31 and the outer member 32 is a vaporization chamber 30A. A height D of the vaporization chamber 30A is, for example, within 1 mm, and specifically about 0.5 mm.

The inner member 31 and the outer member 32 are made of a material having high heat conductivity and superior corrosion resistance such as stainless steel, aluminum (Al), and titanium (Ti). In the inner member 31, a through hole through which a vaporized fuel passes is provided. The vaporization chamber 30A is sealed with a sealing material 33 such as fluorine rubber and silicon rubber, and shielded from outside. The sealing material 33 may be previously integrated with the outer member 32, or may be a member different from the outer member 32.

FIG. 2 illustrates a case that the inner member 31 is tabular and the outer member 32 has a concave structure surrounding five sides of the vaporization chamber 30A (the cross sectional view of FIG. 2 illustrates three sides thereof). However, the outer member 32 does not necessarily have an integrated concave structure. The outer member 32 may have a concave structure formed by attaching a frame to a tabular member.

In the vaporization chamber 30A, a projection 41 is provided as a heat conduction section to conduct heat generated in the power generation section 10 to the liquid fuel supplied to the vaporization chamber 30A. Thereby, in the fuel cell system 1, excessive supply or supply shortage of the vaporized fuel is able to be avoided and stable power generation with high output is able to be made.

The projection 41 is formed from an inner wall face of the outer member 32 toward an inner wall face of the inner member 31. In the projection 41, an end section of the fuel supply route 24 is formed. Between the end of the projection 41 and the inner wall face of the inner member 31, a gap G is provided. In the gap G, heat is effectively conducted to the liquid fuel supplied from the end of the fuel supply route 24, and the liquid fuel is able to be vaporized. The gap G is desirably, for example, within 1 mm, and specifically about 0.5 mm, since thereby higher effect is obtained.

In the case where the projection 41 is provided in part of the inside of the vaporization chamber 30A as described above, there is another advantage that the fuel volume increase due to vaporization is able to be absorbed more than in a case that the height D itself of the vaporization chamber 30A is decreased.

As illustrated in FIG. 3, the projection 41 may be formed from the inner wall face of the inner member 31 toward the inner wall face of the outer member 32. In this case, the end of the projection 41 is desirably arranged to oppose an aperture of the end of the fuel supply route 24. Further, as in FIG. 2, between the end of the projection 41 and the inner wall face of the inner member 31, the gap G is desirably provided. Thereby, in the gap G, heat is effectively conducted to the liquid fuel supplied from the end of the fuel supply route 24, and the liquid fuel is able to be vaporized. The gap G is, for example, desirably within 1 mm, and specifically about 0.5 mm as in FIG. 2.

The fuel cell system 1 is able to be manufactured, for example, as follows.

First, the electrolyte film 13 made of the foregoing material is sandwiched between the anode electrode 11 and the cathode electrode 12 made of the foregoing material and the resultant is thermally compression-bonded. Thereby, the anode electrode 11 and the cathode electrode 12 are jointed with the electrolyte film 13 to form the power generation section 10. Outside the cathode electrode 12, the package member 14 made of the foregoing material is arranged.

Next, the inner member 31 and the outer member 32 made of the foregoing material are prepared. The projection 41 as illustrated in FIG. 2 or FIG. 3 is formed in one of the inner member 31 and the outer member 32. The inner member 31 and the outer member 32 are assembled and the resultant assembly is sealed with the sealing material 33. Thereby, the fuel vaporization section 30 having the vaporization chamber 30A is formed, and the projection 41 is formed in the vaporization chamber 30A. The fuel vaporization section 30 is arranged adjacent to the anode electrode 11.

Next, the power generation section 10 and the fuel vaporization section 30 are incorporated into the foregoing system having the fuel supply control section 20 composed of the fuel tank 21, the fuel pump 22, the control section 23, and the fuel supply route 24 and the external circuit 2, and the end section of the fuel supply route 24 is connected to the vaporization chamber 30A. Accordingly, the battery system 1 illustrated in FIG. 1 is completed.

In the fuel cell system 1, methanol as a fuel is supplied to the anode electrode 11, and reaction is initiated to generate protons and electrons. The protons are moved through the electrolyte film 13 to the cathode electrode 12, are reacted with electrons and oxygen to generate water. Reactions initiated in the anode electrode 11, the cathode electrode 12, and the entire power generation section 10 are shown in Chemical formula 4. Thereby, chemical energy of methanol as a fuel is converted to electric energy, a current is extracted from the power generation section 10, and the external circuit 2 is driven.

Chemical formula 4

Anode electrode 10: CH₃OH+H₂O→CO₂+6H⁺+6c⁻

Cathode electrode 20: 6H⁺+(3/2)O₂+6e⁺+→3H₂O

Entire power generation section 10: CH₃OH+(3/2)O₂→CO₂+2H₂O

In operating the power generation section 10, an operation voltage and an operation current of the power generation section 10 are measured by the control section 23. Based on the measurement results, the power generation amount of the power generation section 10 and the fuel supply amount based on the stoichiometric fuel consumption corresponding to the power generation amount of the power generation section 10 are calculated. The control section 23 controls the fuel pump 22, and supplies the liquid fuel whose amount is based on the stoichiometric fuel consumption corresponding to the power generation amount of the power generation section 10 to the vaporization chamber 30A through the fuel supply route 24. Thus, even if heat conduction becomes excessive being influenced by environment temperature, power generation state of the power generation section 10 or the like, there is no possibility that the gas fuel is excessively supplied. Thus, crossover due to excessive fuel is inhibited, temperature of the power generation section 10 is not excessively increased, and power generation efficiency is inhibited from being lowered.

Further, the projection 41 is formed in the vaporization chamber 30 as a heat conduction section. Thus, by the projection 41, the heat generated in the power generation section 10 is conducted to the liquid fuel, and the liquid fuel is vaporized. Thus, there is no possibility that supply shortage of the vaporized fuel due to lack of heat conduction. Accordingly, an appropriate amount of liquid fuel is surely vaporized and is supplied to the power generation section 10.

Further, since temperature of the vaporization chamber 30A is increased, the partial pressure of the fuel and moisture vapor is increased and a state advantageous to electrode reaction is obtained. At the same time, heat is effectively removed from the power generation section 10, and power generation output is inhibited from being lowered due to drying of the electrolyte film 13.

As described above, in this embodiment, the fuel supply control section 20 supplies the liquid fuel whose amount is based on the stoichiometric fuel consumption corresponding to the power generation amount of the power generation section 10 to the vaporization chamber 30A. In addition, the projection 41 is formed in the vaporization chamber 30A as a heat conduction section to conduct heat generated in the power generation section 10 to the liquid fuel supplied to the vaporization chamber 30A. Thus, excessive supply, supply shortage or the like of the fuel is able to be avoided. Accordingly, high output is able to be obtained, and stability of power generation is able to be improved. Therefore, the present invention is suitable for an electronic device having high electric power consumption, multi functions, and high performance.

Further, since temperature of the vaporization chamber 30A is able to be increased, the partial pressure of the fuel and moisture vapor is increased and a state advantageous to electrode reaction is able to be obtained. At the same time, heat is effectively removed from the power generation section 10, and power generation output is inhibited from being lowered due to drying of the electrolyte film 13.

### Second Embodiment

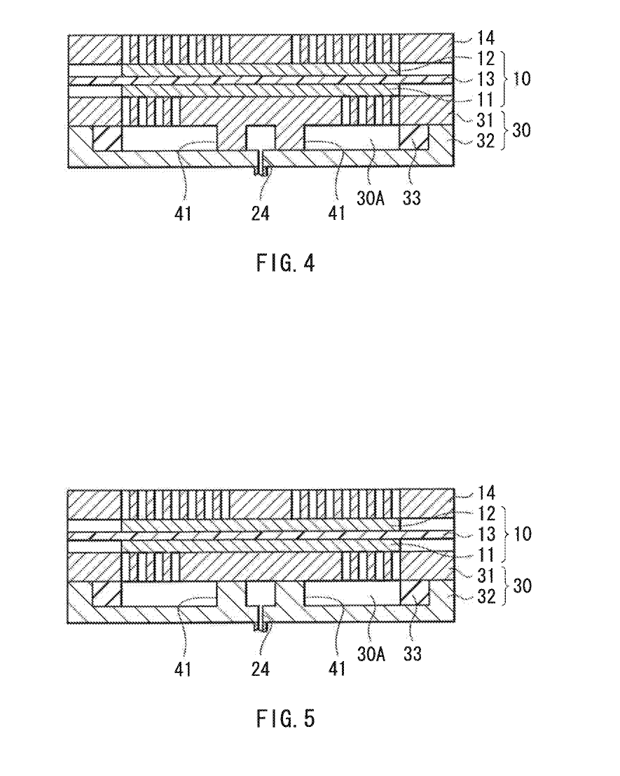

FIG. 4 and FIG. 5 illustrate a structure of the power generation section 10 and the fuel vaporization section 30 according to a second embodiment. This embodiment has the same structure as that of the foregoing first embodiment, except that the end of the projection 41 is contacted with the inner wall face of the outer member 32 in FIG. 4, and the projection 41 is contacted with the inner wall face of the inner member 31 in FIG. 5, and is able to be manufactured in the same manner as that of the foregoing first embodiment.

The projection 41 is contacted with a section in the vicinity of the end section of the fuel supply route 24 in the inner wall face of the outer member 32 or the inner wall face of the inner member 31. Thereby, in this embodiment, heat of the power generation section 10 is conducted to the outer member 32 or the inner member 31 through the projection 41. The heat is conducted to the liquid fuel supplied from the fuel supply route 24 through the outer member 32 or the inner member 31, and thereby the liquid fuel is able to be vaporized. Further, it is possible to limit a target region to be heated out of the outer member 32 or the inner member 31 according to the position of the projection 41, or to control the amount of heat conducted to the liquid fuel according to the size of the projection 41. Further, in this embodiment, since it is not necessary to control the tolerance of the gap G, the manufacturing step is able to become easier.

### Third Embodiment

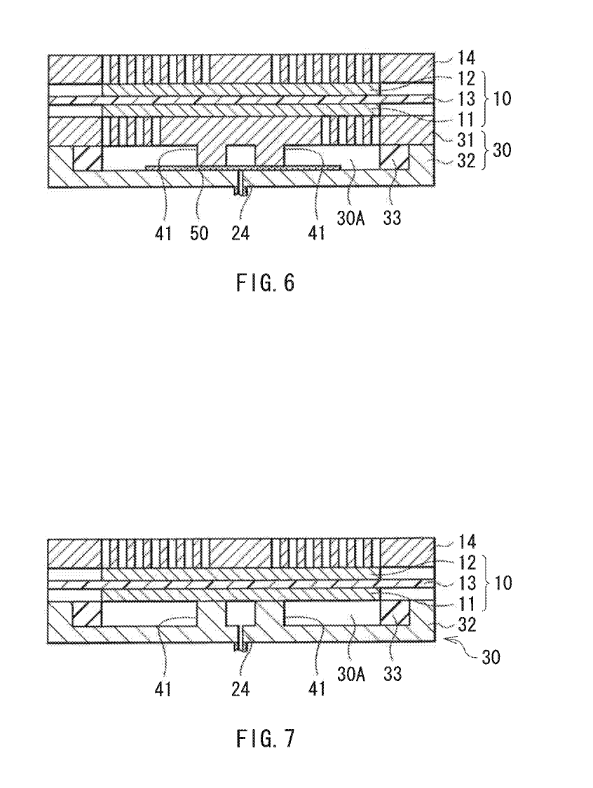

FIG. 6 illustrates a structure of the power generation section 10 and the fuel vaporization section 30 according to a third embodiment. In this embodiment, a diffusion sheet 50 to diffuse the liquid fuel supplied to the vaporization chamber 30A is provided in the inner wall face of the outer member 32. Thereby, in this embodiment, the liquid fuel supplied from the fuel supply route 24 is diffused in plane direction by the diffusion sheet 50, and the fuel is able to be vaporized more effectively and uniformly.

The diffusion sheet 50 is made of a resin such as porous polyethylene and porous polypropylene. The diffusion sheet 50 is provided in the outlet of the fuel supply route 24 or in the vicinity of the outlet. The end of the projection 41 may be contacted with the diffusion sheet 50. Otherwise, the gap G may be provided between the end of the projection 41 and the diffusion sheet 50.

### Fourth Embodiment

FIG. 7 illustrates a structure of the power generation section 10 and the fuel vaporization section 30 according to a fourth embodiment. In this embodiment, the fuel vaporization section 30 only has the outer member 32. That is, the outer member 32 is arranged opposite to the anode electrode 11 with the vaporization chamber 30A in between. The end of the projection 41 is contacted with the anode electrode 11. Thereby, in this embodiment, it is possible to omit the inner member 31 to obtain the thinner and smaller fuel vaporization section 30.

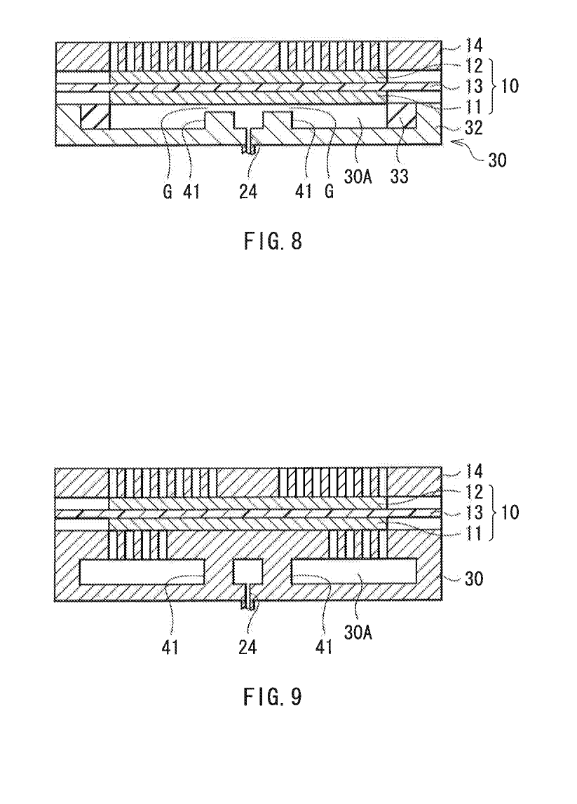

As illustrated in FIG. 8, the gap G as illustrated in FIG. 2 or FIG. 3 may be provided between the end of the projection 41 and the anode electrode 11.

Further, though not illustrated, in this embodiment, as in the third embodiment, the diffusion sheet 50 may be provided in the inner wall face of the outer member 32.

### Fifth Embodiment

FIG. 9 illustrates a structure of the power generation section 10 and the fuel vaporization section 30 according to a fifth embodiment. In this embodiment, the inner member 31 and the outer member 32 are integrated. Thereby, it is possible to obtain the thinner and smaller fuel vaporization section 30.

Further, though not illustrated, in this embodiment, as in the third embodiment, the diffusion sheet 50 may be provided in the inner wall face of the outer member 32.

### Sixth Embodiment

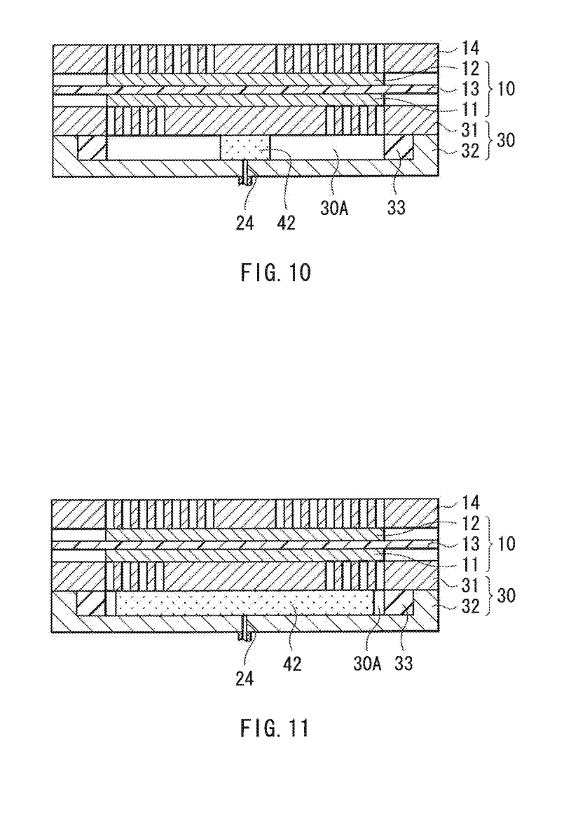

FIG. 10 illustrates a structure of the power generation section 10 and the fuel vaporization section 30 according to a sixth embodiment. In this embodiment, in part of inside of the vaporization chamber 30A, a diffusion heat conduction member 42 made of a porous body or a nonwoven cloth is provided as a heat conduction section. Thereby, in this embodiment, it is possible that the contact area between the liquid fuel and the diffusion heat conduction member 42 is increased, heat is easily conducted to the liquid fuel, and thereby vaporization is able to be made effectively. Further, by providing the diffusion heat conduction member 42 in part of inside of the vaporization chamber 30A, a space to absorb volume increase portion of the vaporized fuel is able to be secured.

As the porous body, a foam body or a sintered body of a metal having favorable heat conductivity such as nickel, stainless steel, and titanium is preferable. Otherwise, in the case where the height D of the vaporization chamber 30A is within 1 mm, for example, about 0.5 mm, a porous body of a material having comparatively low heat conductivity such as a resin may be used.

In this embodiment, the liquid fuel supplied from the fuel supply route 24 is diffused inside the diffusion heat conduction member 42 while heat is conducted thereto, and accordingly the liquid fuel is effectively vaporized.

As illustrated in FIG. 11, the diffusion heat conduction member 42 may be provided in the entire vaporization chamber 30A. In this case, since the fuel supply amount is appropriately controlled by the fuel supply control section 20 illustrated in FIG. 1, there is no possibility that vaporized fuel is excessively supplied.

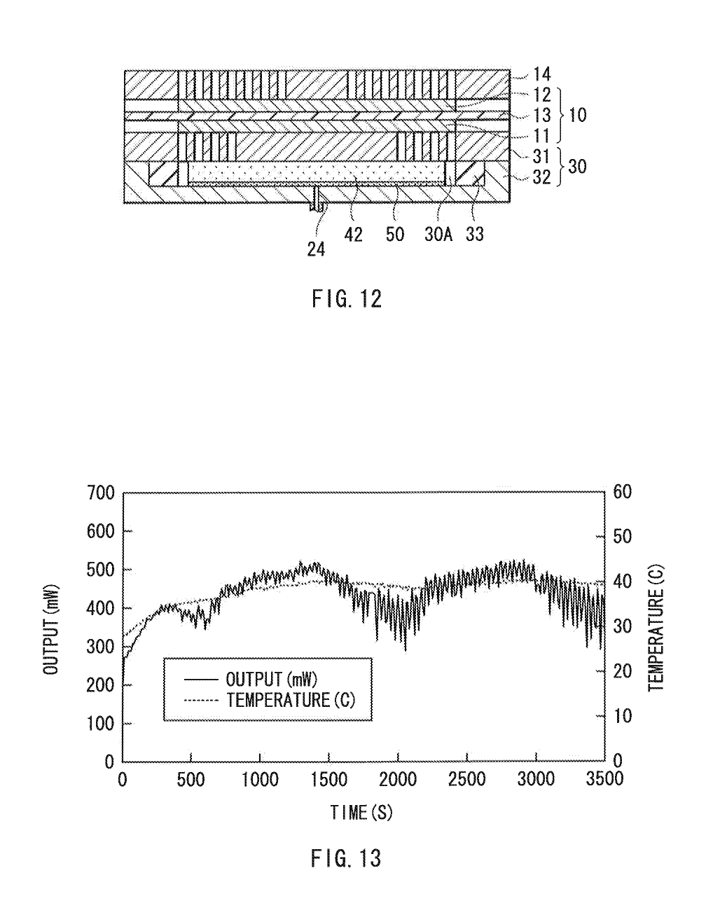

Further, as illustrate in FIG. 12, the diffusion sheet 50 may be provided in the inner wall face of the outer member 32. By promoting diffusion in plane direction of the liquid fuel by the diffusion sheet 50, the fuel is able to be more effectively and uniformly vaporized.

### EXAMPLE

Further, a specific example will be described.

The fuel cell system 1 having the power generation section 10, the fuel supply control section 20, and the fuel vaporization section 30 illustrated in FIG. 1 and FIG. 12 was fabricated. At this time, the diffusion sheet 50 was provided in the inner wall face of the outer member 32, and the diffusion heat conduction member 42 made of a porous body composed of a nickel foam body was provided in the almost entire vaporization chamber 30A. For the obtained fuel cell system 1, change of output and change of temperature of the power generation section 10 associated with time passage were also examined. The result is illustrated in FIG. 13. The average output at this time was 380 mW.

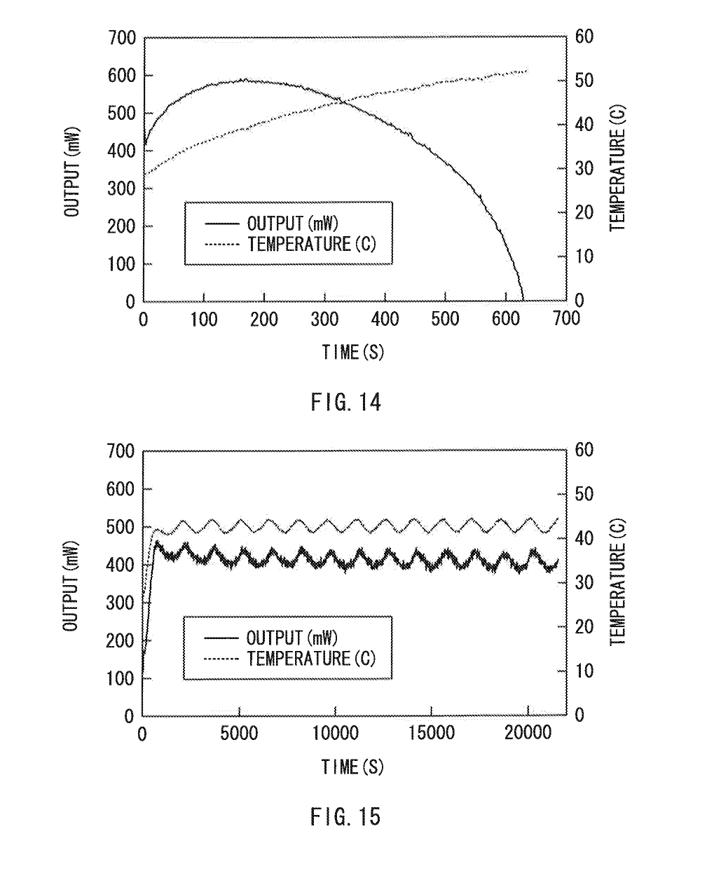

As Comparative example 1 to this example, a fuel cell system was fabricated in the same manner as that of this example, except that fuel supply control by the fuel supply control section was not made, and the diffusion sheet and the diffusion heat conduction member were omitted. For Comparative example 1, change of output and change of temperature of the power generation section associated with time passage were examined. The result is illustrated in FIG. 14. The average output at this time was 230 mW.

(Long Term Power Generation Characteristics)

For the fuel cell system 1 of the foregoing example, long term power generation characteristics were examined. The result is illustrated in FIG. 15. The average output at this time was 410 mW.

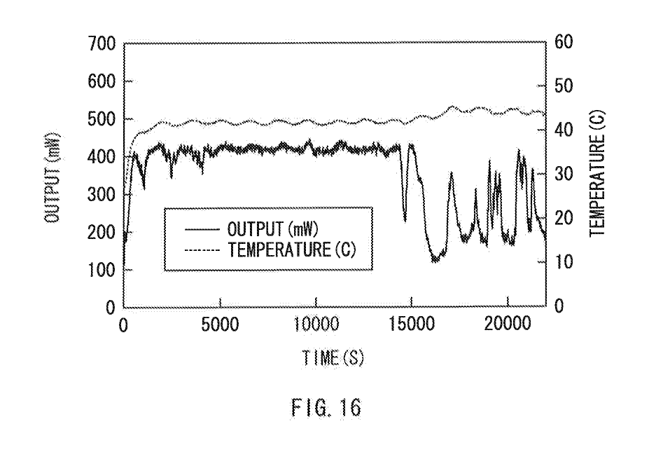

As Comparative example 2, a fuel cell system was fabricated in the same manner as that of Comparative example 1, except that fuel supply control by the fuel supply control section was made, and the diffusion sheet and the diffusion heat conduction member were omitted. For Comparative example 2, long term power generation characteristics were examined. The result is illustrated in FIG. 16. The average output at this time was 350 mW.

As evidenced by FIG. 13 and FIG. 14, comparing the example to Comparative example 1, in Comparative example 1 in which fuel supply control by the fuel supply control section was not made, and the diffusion sheet and the diffusion heat conduction member were not provided, fuel supply became excessive, crossover was increased, temperature increase of the power generation section was intense, and power generation output was drastically lowered. Meanwhile, in this example in which heat conductivity to the liquid fuel was improved by the diffusion sheet 50 and the diffusion heat conduction member 42 while fuel supply control by the fuel supply control section 20 was made, even if time lapses, both temperature and power generation characteristics of the power generation section 10 were stable. Further, according to this embodiment, high average output as about 1.7 times as many as that of Comparative example 1 was able to be obtained.

That is, it was found as follows. That is, in the case where the liquid fuel whose amount was based on the stoichiometric fuel consumption corresponding to the power generation amount of the power generation section 10 was supplied to the vaporization chamber 30A, and the heat generated in the power generation section 10 was conducted to the liquid fuel supplied to the vaporization chamber 30A by providing the diffusion heat conduction member 42 made of the porous body and the diffusion sheet 50 in the vaporization chamber 30A, excessive supply of the vaporized fuel was prevented, and stable power generation with increased output was able to be made.

Further, as evidenced by the long term power generation data illustrated in FIG. 15 and FIG. 16, comparing the example to Comparative example 2, in Comparative example 2 in which fuel supply control by the fuel supply control section was made, and the diffusion sheet and the diffusion heat conduction member were not provided, the output started to be drastically lowered at the time of around 14000 sec, and the average output became low. In Comparative example 2, since the diffusion sheet and the diffusion heat conduction member were not provided, heat was not sufficiently conducted to the liquid fuel, and supply of the vaporized fuel was lacked. Meanwhile, in the example in which heat conductivity to the liquid fuel was improved by the diffusion sheet 50 and the diffusion heat conduction member 42 while fuel supply control by the fuel supply control section 20 was made, stable and power generation was made continuously, and the average output was high as about 1.2 times as many as that of Comparative example 2.

That is, it was found as follows. That is, in the case where the liquid fuel whose amount was based on the stoichiometric fuel consumption corresponding to the power generation amount of the power generation section 10 was supplied to the vaporization chamber 30A, and the heat generated in the power generation section 10 was conducted to the liquid fuel supplied to the vaporization chamber 30A by providing the diffusion heat conduction member 42 made of the porous body and the diffusion sheet 50 in the vaporization chamber 30A, supply shortage of the vaporized fuel was prevented, output was increased, and stable power generation was able to be made continuously for a long time.

In the foregoing embodiments and the foregoing example, the description has been given specifically of the structures of the power generation section 10, the fuel supply control section 20, the fuel vaporization section 30, the projection 41, and the diffusion heat conduction member 42. However, the power generation section 10, the fuel supply control section 20, the fuel vaporization section 30, the projection 41, and the diffusion heat conduction member 42 may have other structure, or may be made of other material.

Further, for example, in the foregoing embodiments and the foregoing example, the description has been given of the case that one power generation section 10 is included. However, the present invention is able to be applied to a case that a plurality of power generation sections 10 are layered in the vertical direction (lamination direction) or in the horizontal direction (lamination in-plane direction) to structure a fuel cell stack. In particular, in the case where the plurality of power generation sections 10 are layered in the horizontal direction, there is a possibility that bias exists in the fuel vaporized amount according to the in-plane temperature distribution of the fuel vaporization section 30 or the distribution of heat conduction from the power generation 10. However, even in the case of the foregoing flat power generation body, by providing the projection 41 or the diffusion heat conduction member 42 in the vaporization chamber 30A of the fuel vaporization section 30, an appropriate amount of fuel is able to be surely vaporized and the vaporized fuel is able to be supplied to the power generation section 10. In addition, in this case, a heater, an atomizer or the like that may cause increase of electric power consumption is able to be unneeded.

In addition, for example, the material and the thickness of each element, or the power generation conditions of the power generation section 10 and the like are not limited to those described in the foregoing embodiments and the foregoing example. Other material, other thickness, or other power generation conditions may be adopted.

In addition, for example, the liquid fuel may be other liquid fuel such as ethanol and dimethyl ether other than methanol.

Furthermore, in the foregoing embodiments and the foregoing example, air supply to the cathode electrode 12 is made by natural ventilation. However, air may be forcefully supplied by using a pump or the like. In this case, instead of air, oxygen or gas containing oxygen may be supplied.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-12. (canceled)

13: A fuel cell system comprising:
a power generation section including an electrolyte between an anode electrode and a cathode electrode;
a fuel supply control section that supplies a liquid fuel whose amount is based on a stoichiometric fuel consumption according to a power generation amount of the power generation section;
a fuel vaporization section that is arranged adjacent to the anode electrode, and has a vaporization chamber to which the liquid fuel from the fuel supply control section is supplied; and
a heat conduction section that is formed in the vaporization chamber, and conducts heat generated in the power generation section to the liquid fuel supplied to the vaporization chamber.

14: The fuel cell system according to claim 13, wherein the fuel vaporization section has an inner member arranged adjacent to the anode electrode and an outer member arranged oppositely to the inner member with the vaporization chamber in between, and
the heat conduction section is a projection that is formed from an inner wall face of the inner member toward an inner wall face of the outer member, or is formed from the inner wall face of the outer member toward the inner wall face of the inner member.

15: The fuel cell system according to claim 14, wherein a gap is provided between an end of the projection and the inner wall face of the outer member or the inner wall face of the inner member.

16: The fuel cell system according to claim 14, wherein an end of the projection is contacted with the inner wall face of the outer member or the inner wall face of the inner member.

17: The fuel cell system according to claim 14, wherein the inner member and the outer member are integrated.

18: The fuel cell system according to claim 13, wherein the fuel vaporization section has an outer member arranged oppositely to the anode electrode with the vaporization chamber in between, and
the heat conduction section is a projection that is formed from an inner wall face of the outer member toward the anode electrode.

19: The fuel cell system according to claim 18, wherein a gap is provided between an end of the projection and the anode electrode.

20: The fuel cell system according to claim 18, wherein an end of the projection is contacted with the anode electrode.

21: The fuel cell system according to claim 14, wherein a diffusion sheet that diffuses the liquid fuel supplied to the vaporization chamber is provided on the inner wall face of the outer member.

22: The fuel cell system according to claim 13, wherein the heat conduction section is a diffusion heat conduction member that is provided in at least part of the vaporization chamber, and is made of a porous body or an unwoven cloth.

23: The fuel cell system according to claim 22, wherein the fuel vaporization section has an inner member arranged adjacent to the anode electrode and an outer member arranged oppositely to the inner member with the vaporization chamber in between, and
a diffusion sheet that diffuses the liquid fuel supplied to the vaporization chamber is provided on an inner wall face of the outer member.

24: An electronic device including a fuel cell system, wherein the fuel cell system comprises:
a power generation section including an electrolyte between an anode electrode and a cathode electrode;
a fuel supply control section that supplies a liquid fuel whose amount is based on a stoichiometric fuel consumption according to a power generation amount of the power generation section;
a fuel vaporization section that is arranged adjacent to the anode electrode, and has a vaporization chamber to which the liquid fuel from the fuel supply control section is supplied; and
a heat conduction section that is formed in the vaporization chamber, and conducts heat generated in the power generation section to the liquid fuel supplied to the vaporization chamber.
